(19) United States
(12) Patent Application Publication
(10) Pub. No.: US 2011/0152159 A1
(43) Pub. Date: Jun. 23, 2011

(54) COMPOSITION COMPRISING MICROCAPSULES

(76) Inventor: Régine Labeque, Neder over Heembeek (BE)

(21) Appl. No.: 12/957,606

(22) Filed: Dec. 1, 2010

(30) Foreign Application Priority Data
Dec. 18, 2009 (EP) 09 179 935.3

(51) Int. Cl. C11D 17/00

(52) U.S. Cl. 510/296; 510/337

(57) ABSTRACT

The present invention relates to a liquid detergent composition comprising from 0.01 to 40% by weight water, benefit agent-containing microcapsules and an ionic species having at least 2 anionic sites, wherein the ionic strength delivered by the ionic species having at least 2 anionic sites is greater than 0.045 mol/kg.

### TECHNICAL FIELD

The present application relates to a composition comprising perfume microcapsules and the stability thereof in detergent compositions.

### BACKGROUND TO THE INVENTION

Benefit agents, such as perfumes, silicones, waxes, flavors, vitamins and fabric softening agents, are expensive and generally less cost effective when employed at high levels in personal care compositions, cleaning compositions, and fabric care compositions. As a result, there is a desire to maximize the effectiveness of such benefit agents. One method of achieving such an objective is to improve the delivery efficiency and active lifetime of the benefit agent. This can be achieved by providing the benefit agent as a component of a microcapsule.

Microcapsules provide several benefits. They have the benefit of protecting the benefit agent from physical or chemical reactions with incompatible ingredients in the composition, volatilization or evaporation. Microcapsules have the further advantage in that they can deliver the benefit agent to the substrate and can be designed to rupture under desired conditions, such as when a fabric becomes dry. Microcapsules can be particularly effective in the delivery and preservation of perfumes. Perfumes can be delivered to and retained within the fabric by a microcapsule that only ruptures, and therefore releases the perfume, when the fabric is dry.

Microcapsules are made either by supporting the benefit agent on a water-insoluble porous carrier or by encapsulating the benefit agent in a water-insoluble shell. In the latter category microencapsulates are made by precipitation and deposition of polymers at the interface, such as in coacervates, for example as disclosed in GB-A-0 751 600, U.S. Pat. No. 3,341,466 and EP-A-0 385 534, or other polymerisation routes such as interfacial condensation U.S. Pat. No. 3,577,515, US-A-2003/0125222, U.S. Pat. No. 6,020,066, WO2003/101606, U.S. Pat. No. 5,066,419. A particularly useful means of encapsulation is using the melamine/urea—formaldehyde condensation reaction as described in U.S. Pat. No. 3,516,941, U.S. Pat. No. 5,066,419 and U.S. Pat. No. 5,154,842. Such capsules are made by first emulsifying a benefit agent in small droplets in a pre-condensate medium obtained by the reaction of melamine/urea and formaldehyde and then allowing the polymerisation reaction to proceed along with precipitation at the oil-water interface. The encapsulates range in size from a few micrometer to a millimeter are then obtained in a suspension form in an aqueous medium.

However, the most challenging problem with respect to the incorporation of microcapsules in detergent compositions is their stability. The benefit agent, particularly perfumes leak from within the microcapsule over time. This is especially true when the composition comprises surfactant and solvent, as most detergent compositions do. The applicant has surprisingly found a solution to this problem in the construction of the composition.

### SUMMARY OF THE INVENTION

According to the present invention there is provided a liquid detergent composition comprising from 0.01 to 40% by weight water, benefit agent-containing microcapsules and an ionic species having at least 2 anionic sites, wherein the ionic strength delivered by the ionic species having at least 2 anionic sites, is greater than 0.045 mol/kg.

### DETAILED DESCRIPTION OF THE INVENTION

The liquid compositions of the present invention are preferably suitable for use as hard surface cleaning, but preferably laundry treatment compositions.

The term liquid is meant to include viscous or fluid liquids with newtonian or non-Newtonian rheology and gels. Said composition may be packaged in a container or as an encapsulated unitized dose. The latter form is described in more detail below. The liquid compositions are essentially non-aqueous. By non-aqueous it is understood that the compositions of the present invention comprise less than 20% total water, preferably from 1 to 15%, most preferably from 1 to 10% total water. By total water it is understood to mean both free and bound water. Compositions used in unitized dose products comprising a liquid composition enveloped within a water-soluble film are often described to be non-aqueous. The compositions of the present invention preferably have viscosity from 1 to 10000 centipoises (1-10000 mPa*s), more preferably from 100 to 7000 centipoises (100-7000 mPa*s), and most preferably from 200 to 1500 centipoises (200-1500 mPa*s) at 20 s⁻¹ and 21° C. Viscosity can be determined by conventional methods. Viscosity, according to the present invention, however is measured using an AR 550 rheometer from TA instruments using a plate steel spindle at 40 mm diameter and a gap size of 500 μm.

### Microcapsule

The composition of the present invention comprises microcapsules. More preferably the microcapsules comprise a benefit agent. The microcapsule preferably comprises a core material and a wall material that at least partially surrounds said core.

In one aspect, at least 75%, 85% or even 90% of said microcapsules may have a particle size of from about 1 microns to about 80 microns, about 5 microns to 60 microns, from about 10 microns to about 50 microns, or even from about 15 microns to about 40 microns. In another aspect, at least 75%, 85% or even 90% of said benefit agent delivery particles may have a particle wall thickness of from about 60 nm to about 250 nm, from about 80 nm to about 180 nm, or even from about 100 nm to about 160 nm.

In one aspect, said benefit agent may comprise a material selected from the group consisting of perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, dyes, brighteners, antibacterial actives, antiperspirant actives, cationic polymers and mixtures thereof. In one aspect, said benefit agent is a perfume raw material. In a further aspect the perfume raw material is selected from the group consisting of alcohols, ketones, formaldehydes, esters, ethers, nitriles alkenes. Preferably the benefit agent is a perfume raw material and/or optionally a material selected from the group consisting of vegetable oil, including neat and/or blended vegetable oils including caster oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof; aromatic solvents, including benzene, toluene and mixtures thereof; silicone oils; and mixtures there of.

In one aspect, said microcapsule wall material may comprise a suitable resin including the reaction product of an aldehyde and an amine, suitable aldehydes include, formaldehyde. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof. Suitable materials for making may be obtained from one or more of the following companies Solutia Inc. (St Louis, Mo. U.S.A.), Cytec Industries (West Paterson, N.J. U.S.A.), sigma-Aldrich (St. Louis, Mo. U.S.A.). It has been found that it is possible to prepare microcapsules comprising a melamine-5 formaldehyde aminoplast terpolymer containing polyol moieties, and especially aromatic polyol moieties. There are therefore provided microcapsules comprising a core of benefit agent, preferably fragrance, and a shell of aminoplast polymer, the composition of the shell being from 75-100% of a thermoset resin comprising 50-90%, preferably from 60-85%, of a terpolymer and from 10-50%, preferably from 10-25%, of a polymeric stabilizer; the terpolymer comprising: (a) from 20-60%, preferably 30-50% of moieties derived from at least one polyamine, (b) from 3-50%, preferably 5-25% of moieties derived from at least one aromatic polyol; and (c) from 20-70%, preferably 40-60% of moieties selected from the group consisting of alkylene and alkylenoxy moieties having 1 to 6 methylene units, preferably 1 to 4 methylene units and most preferably a methylene unit, dimethoxy methylene and dimethoxy methylene. By “moiety” is meant a chemical entity, which is part of the terpolymer and which is derived from a particular molecule. Example of suitable polyamine moieties include, but are not limited to, those derived from urea, melamine, 3-substituted 1, 5-30 diamino-2,4,6-triazin and glycouril. Examples of suitable aromatic polyol moieties include, but are not limited to, those derived from phenol, 3,5-dihydroxy toluene, Bisphenol A, resorcinol, hydroquinone, xylenol, polyhydroxy naphthalene and polyphenols produced by the degradation of cellulose and humic acids.

The use of the term “derived from” does not necessarily mean that the moiety in the terpolymer is directly derived from the substance itself, although this may be (and often is) the case. In fact, one of the more convenient methods of preparing the terpolymer involves the use of alkylolated polyamines as starting materials; these combine in a single molecule both the moieties (a) and (c) mentioned hereinabove.

Suitable alkylolated polyamines encompass mixtures of mono- or polyalkylolated polyamines, which in turn may be partially alkylated with alcohols having from 1 to 6 methylene units. Alkylated polyamines especially suitable for the sake of the present invention include mono- and polymethylol-urea pre-condensates, such as those commercially available under the Trade Mark URAC (ex Cytec Technology Corp.) and/or partially methylated mono- and polymethylol-1,3,5-triamino-2,4,6-triazine pre-condensates, such as those commercially available under the Trade Mark CYMEL (ex Cytec Technology Corp.) or LURACOLL (ex BASF), and/or mono- and polyalkylol-benzoguanamine pre-condensates, and/or mono- and polyalkylol-glycouril pre-condensates. These alkylolated polyamines may be provided in partially alkylated forms, obtained by addition of short chain alcohols having typically 1 to 6 methylene units. These partially alkylated forms are known to be less reactive and therefore more stable during storage. Preferred polyalkylol-polyamines are polymethylol-melamines and polymethylol-1-(3,5-dihydroxy-methylbenzyl)-3,5-triamino-2,4,6-triazine.

A polymeric stabilizer may be used to prevent the microcapsules from agglomerating, thus acting as a protective colloid. It is added to the monomer mixture prior to polymerisation, and this results in its being partially retained by the polymer. Particular examples of suitable polymeric stabilizers include acrylic copolymers bearing sulfonate groups, such as those available commercially under the trade mark LUPASOL (ex BASF), such as LUPASOL PA 140 or LUPASOL VFR; copolymers of acrylamide and acrylic acid, copolymers of alkyl acrylates and N-vinylpyrrolidone, such as those available under the trade mark Luviskol (e.g. LUVISKOL K 15, K 30 or K 90 ex BASF); sodium polycarboxylates (ex Polyscience Inc.) or sodium poly(styrene sulfonate) (ex Polyscience Inc.); vinyl and methyl vinyl ether—maleic anhydride copolymers (e.g. AGRIMER&#8482; VEMA&#8482; AN, ex ISP), and ethylene, isobutylene or styrene-maleic anhydride copolymers. Hence the preferred polymer stabilizers are anionic polyelectrolytes.

Microcapsules of the type hereinabove described are manufactured in the form of an aqueous slurry, having typically 20 to 50% solids content, and more typically 30 to 45% solid content, where the term “solids content” refers to the total weight of the microcapsules. The slurry may contain formulation aids, such as stabilizing and viscosity control hydrocolloids, biocides, and additional formaldehyde scavengers.

Typically, hydrocolloids or emulsifiers are used during the emulsification process of the benefit agent, most particularly a perfume. Such colloids improve the stability of the slurry against coagulation, sedimentation and creaming. The term “hydrocolloid” refers to a broad class of water-soluble or water-dispersible polymers having anionic, cationic, zwitterionic or non-ionic character. Said hydrocolloids/emulsifiers may comprise a moiety selected from the group consisting of carboxy, hydroxyl, thiol, amine, amide and combination thereof. Hydrocolloids useful for the sake of the present invention encompass: polycarbohydrates, such as starch, modified starch, dextrin, maltodextrin, and cellulose derivatives, and their quaternized forms; natural gums such as alginate esters, carrageenan, xanthanes, agar-agar, pectines, pectic acid, and natural gums such as gum arabic, gum tragacanth and gum karaya, guar gums and quaternized guar gums; gelatine, protein hydrolysates and their quaternized forms; synthetic polymers and copolymers, such as poly(vinyl pyrrolidone-co-vinyl acetate), poly(vinyl alcohol-co-vinyl acetate), poly((met)acrylic acid), poly(maleic acid), poly(alkyl(meth)acrylate-co-(meth)acrylic acid), poly(acrylic acid-co-maleic acid)copolymer, poly(alkyleneoxide), poly(vinylmethylether), poly(vinylether-co-maleic anhydride), and the like, as well as poly-(ethyleneimine), poly((meth)acrylamide), poly(alkyleneoxide-co-dimethylsiloxane), poly(amino dimethylsiloxane), and the like, and their quartenized forms. In one aspect, said emulsifier may have a pKa of less than 5, preferably greater than 0, but less than 5. Emulsifiers include acrylic acid-alkyl acrylate copolymers, poly(acrylic acid), polyoxyalkylene sorbitan fatty esters, polyalkylene co-carboxy anhydrides, poly alkylen co-maleic anhydrides, poly(methyl vinyl ether-co-maleic anhydride), poly(butadiene co-maleic acnhydride), and poly(vinyl acetate-co-maleic anhydride), polyvinyl alcohols, polyealkylene glycols, polyoxyalkylene glycols and mixtures thereof. Most preferably the hydrocolloid is polyacrylic acid or modified polyacrylic acid. The pKa of the colloids is preferably between 4 and 5, and hence the capsule has a negative charge when the PMC slurry has pH above 5.0.

The microcapsules preferably comprise a nominal shell to core mass ratio lower than 15%, preferably lower than 10% and most preferably lower than 5%. Hence, the microcapsules may have extremely thin and frangible shells. The shell to core ratio is obtained by measuring the effective amount of encapsulated perfume oil microcapsules that have been previously washed with water and separated by filtration. This is achieved by extracting the wet microcapsule cake by microwave-enhanced solvent extraction and subsequent gas chromatographic analysis of the extract.

Most preferably the benefit agent is encapsulated within an aminoplast capsule, the capsule shell comprising urea-formaldehyde or melamine-formaldehyde polymer. More preferably the microcapsule is further coated or partially coated in a second polymer comprising a polymer or copolymer of one or more anhydrides (such as maleic anhydride or ethylene/maleic anhydride copolymer).

The microcapsules of the present invention may be positively or negatively charged. However it is preferred that the microcapsules of the present invention are negatively charged and have a zeta potential of from −0.1 meV to −100 meV, when dispersed in deionized water. By “zeta potential” (z) it is meant the apparent electrostatic potential generated by any electrically charged objects in solution, as measured by specific measurement techniques. A detailed discussion of the theoretically basis and practical relevance of the zeta-potential can be found, e.g., in “Colloid Science: Zeta Potential in Colloid Sciences: Principles and Applications” (Hunter Robert J.; Editor.; Publisher (Academic Press, London); 1981; p 1988). The zeta-potential of an object is measured at some distance from the surface of the object and is generally not equal to and lower than the electrostatic potential at the surface itself. Nevertheless, its value provides a suitable measure of the capability of the object to establish electrostatic interactions with other objects present in the solution, especially with molecules with multiple binding sites. The zeta-potential is a relative measurement and its value depends on the way it is measured. In the present case, the zeta-potential of the microcapsules is measured by the so-called phase analysis light scattering method, using a Malvern Zetasizer equipment (Malvern Zetasizer 3000; Malvern Instruments Ltd; Worcestershire UK, WR14 1XZ). The zeta potential of a given object may also depend on the quantity of ions present in the solution. The values of the zeta-potential specified in the present application are measured in deionized water, where only the counter-ions of the charged microcapsules are present.

More preferably the microcapsules of the present invention have zeta potential of −10 meV to −80 meV, and most preferred from −20 meV to 75 meV.

Zeta Potential: For purposes of the present specification and claims, zeta potential is determined as follows:
a.) Equipment: Malvern Zetasizer 3000
b.) Procedure for sample preparation:
   (i) Add 5 drops of slurry containing the encapsulate of interest to 20 mL 1 mM NaCl solution to dilute the slurry. The concentration may need adjustment to make the count rate in the range of 50 to 300 Kcps.
   (ii) the zeta potential is measured on the diluted sample without filtration
   (iii) inject the filtered slurry in the Zetasizer cell and insert the cell in the equipment. Test temperature is set at 25° C.
   (iv) when the temperature is stable (usually in 3 to 5 minutes), measurement is started. For each sample, five measurements are taken. Three samples are taken for each slurry of interest. The average of the 15 readings is calculated.
c.) Equipment settings for the measurements:
   Parameters settings for the sample used:

| | |
|---|---|
| Material: | melamine RI 1,680, absorption 0.10 |
| Dispersant: | NaCl 1 mM |
| Temperature: | 25° C. |
| Viscosity: | 0.8900 cP |
| RI: | 1.330 |
| Dielecectric constant: | 100 |
| F(ka) selection: | Model: Smoluchowski F(ka) 1.5 |

Use dispersant viscosity as sample viscosity

| | |
|---|---|
| Cell type: | DTS1060C: clear disposable Zeta cells |
| Measurements: | 3 measurements |

d.) Results: Zeta potential is reported in mV as the average of the 15 readings taken for the slurry of interest.

In one aspect, said microcapsule preferably comprises a perfume benefit agent. The perfume may comprise a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3 and mixtures thereof. Perfume raw materials having a boiling point B.P. lower than about 250° C. and a ClogP lower than about 3 are known as Quadrant I perfume raw materials. Quadrant 1 perfume raw materials are preferably limited to less than 30% of the perfume comprosition. Perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. Suitable Quadrant I, II, III and IV perfume raw materials are disclosed in U.S. Pat. No. 6,869,923 B1.

### Process of Making Microcapsules and Slurry Containing Microcapsules

Microcapsules are commercially available. Processes of making said microcapsules is described in the art. More particular processes for making suitable microcapsules are disclosed in U.S. Pat. No. 6,592,990 B2 and/or U.S. Pat. No. 6,544,926 B1 and the examples disclosed herein.

The slurry of the present invention is the composition resulting from this manufacturing process. Said slurry comprises microcapsules, water and precursor materials for making the microcapsules. The slurry may comprise other minor ingredients, such as an activator for the polymerization process and/or a pH buffer. To the slurry, a formaldehyde scavenger may be added.

### Ionic Species

The compositions of the present invention comprise an ionic species having at least 2 anionic sites. Whilst not wishing to be bound by theory it is believed that the ionic species of the present composition are in some manner protecting the microcapsule. It is hypothesized that the ionic species is forming a barrier layer, be it complete or partial, around the microcapsule. The ionic species is further believed in some instances to be aided by an interaction with cations ions in the composition.

In one aspect of the invention, the ionic species is selected from the group consisting of carboxylic acids, polycarboxylate, phosphate, phosphonate, polyphosphate, polyphosphonate, borate and mixtures thereof, having 2 or more anionic sites. In one aspect, the ionic species is selected from the group consisting of oxydisuccinic acid, aconitic acid, citric acid, tartaric acid, malic acid, maleic acid, fumaric acid, succinic acid, sepacic acid, citaconic acid, adipic acid, itaconic acid, dodecanoic acid and mixtures thereof. In a further aspect of the present invention the composition comprises an ionic species is selected from the group consisting of acrylic acid homopolymers and copolymers of acrylic acid and maleic acid and mixtures thereof.

In a preferred aspect of the present invention, the composition comprises positively charged ions comprising at least 2 cationic sites. Generally such ions are present in the water used as a solvent of the composition or as a component of composition raw materials. Equally, such ions may be counter ions of active ingredients of the compositions. Alternatively, such ions may be added to the composition. In one aspect of the invention, the positively charged ion is selected from calcium, magnesium, iron, manganese, cobalt, copper, zinc ions and mixtures thereof.

The ionic species having at least 2 anionic sites are present in the composition such that they provide an ionic strength of greater than 0.045 mol/kg. More preferably the ionic strength delivered by the ionic species having at least 2 anionic sites is from 0.05 to 2 mol/KG, most preferably from 0.07 to 0.5 mol/Kg. Ionic strength is calculated by the equation:

Ionic Strength=½√(Cᵢzᵢ²)

Where Cᵢ=concentration of ionic species in finished product (mol/kg), z is the charge for the ionic species.

### Optional Composition Ingredients

The liquid compositions of the present invention may comprise other ingredients selected from the list of optional ingredients set out below. Unless specified herein below, an “effective amount” of a particular laundry adjunct is preferably from 0.01%, more preferably from 0.1%, even more preferably from 1% to 20%, more preferably to 15%, even more preferably to 10%, still even more preferably to 7%, most preferably to 5% by weight of the detergent compositions.

Components Comprising Alkyl or Alkenyl Chains Having More than 6 Carbons

Composition according got the present invention preferably comprise one or more components comprising alkyl or alkenyl chains having more than 6 carbons. More preferably the composition comprises from 10% to 90% by weight of one or more components comprising alkyl or alkenyl chains having more than 6 carbons. More preferably 20% to 80%, more preferably from 30% to 70% by weight of one or more components comprising alkyl or alkenyl chains having more than 6 carbons.

Although not limited to surfactants, the component comprising alkyl or alkenyl chains having more than 6 carbons is preferably a surfactant. The surfactant utilized can be of the anionic, nonionic, zwitterionic, ampholytic or cationic type or can comprise compatible mixtures of these types. More preferably surfactants are selected from the group consisting of anionic, nonionic, cationic surfactants and mixtures thereof. Preferably the compositions are substantially free of betaine surfactants. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980. Anionic and nonionic surfactants are preferred.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. Soaps also have a useful building function.

Additional non-soap anionic surfactants which are suitable for use herein include the water-soluble salts, preferably the alkali metal, and ammonium salts, of organic sulfuric reaction products having in their molecular structure an alkyl group containing from about 10 to about 20 carbon atoms, a sulfonic acid or sulfuric acid ester group and optional alkoxylation. (Included in the term “alkyl” is the alkyl portion of acyl groups.) Examples of this group of synthetic surfactants are a) the sodium, potassium and ammonium alkyl sulfates, especially those obtained by sulfating the higher alcohols (C₈-C₁₈ carbon atoms) such as those produced by reducing the glycerides of tallow or coconut oil; b) the sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Especially valuable are linear straight chain alkylbenzene sulfonates in which the average number of carbon atoms in the alkyl group is from about 11 to 13, abbreviated as C₁₁-C₁₃ LAS.

Preferred nonionic surfactants are those of the formula R¹(OC₂H₄)ₙOH, wherein R¹ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

The weight ratio of the component comprising alkyl or alkenyl chains having more than 6 carbons to water-miscible organic solvent with molecular weight of greater than 70 is preferably from 1:10 to 10:1, more preferably from 1:6 to 6:1, still more preferably from 1:5 to 5:1, e.g. from 1:3 to 3:1.

### Water-Miscible Organic Solvent

The compositions of the present invention preferably comprise a water-miscible organic solvent. More preferably the solvent has molecular weight of greater than 70. Preferably the solvent is present in the composition at a level of from 10% to 60% by weight of the composition. More preferably the solvent is present at from 20% to 50% by weight of the composition.

Preferred such solvents include ethers, polyethers, alkylamines and fatty amines, (especially di- and tri-alkyl- and/or fatty-N-substituted amines), alkyl (or fatty) amides and mono- and di-N-alkyl substituted derivatives thereof, alkyl (or fatty) carboxylic acid lower alkyl esters, ketones, aldehydes, polyols, and glycerides.

Specific examples include respectively, di-alkyl ethers, polyethylene glycols, alkyl ketones (such as acetone) and glyceryl trialkylcarboxylates (such as glyceryl tn-acetate), glycerol, propylene glycol, and sorbitol.

Other suitable solvents include higher (C5 or more, eg C5-Cg) alkanols such as hexanol. Lower (C1-C4) alkanols are also useable although they are less preferred and therefore, if present at all, are preferably used in amounts below 20% by weight of the total composition, more preferably less than 10% by weight, still more preferably less than 5% by weight. Alkanes and olefins are yet other suitable solvents. Any of these solvents can be combined with solvent materials which are surfactants and non-surfactants having the aforementioned “preferred” kinds of molecular structure. Even though they appear not to play a role in the deflocculation process, it is often desirable to include them for lowering the viscosity of the product and/or assisting soil removal during cleaning.

### Formaldehyde Scavenger

The compositions of the present invention preferably comprise a formaldehyde scavenger. The formaldehyde scavengers are preferably selected from the group consisting of acetoacetamide, ammonium hydroxide, alkali or alkali earth metal sulfite, bisulfite and mixtures thereof. Most preferably the formaldehyde scavenger is a combination of potassium sulfite and acetoacetamide. The formaldehyde scavenger according to the present invention is present at a total level of from 0.001% to about 3.0%, more preferably from about 0.01% to about 1%.

### Pearlescent Agent

In one embodiment of the present invention the composition may comprise a pearlescent agent. Preferred inorganic pearlescent agents include those selected from the group consisting of mica, metal oxide coated mica, silica coated mica, bismuth oxychloride coated mica, bismuth oxychloride, myristyl myristate, glass, metal oxide coated glass, guanine, glitter (polyester or metallic) and mixtures thereof.

### Fabric Care Benefit Agents

The compositions of the present invention may comprise a fabric care benefit agent. As used herein, “fabric care benefit agent” refers to any material that can provide fabric care benefits such as fabric softening, color protection, pill/fuzz reduction, anti-abrasion, anti-wrinkle, and the like to garments and fabrics, particularly on cotton and cotton-rich garments and fabrics, when an adequate amount of the material is present on the garment/fabric. Non-limiting examples of fabric care benefit agents include cationic surfactants, silicones, polyolefin waxes, latexes, oily sugar derivatives, cationic polysaccharides, polyurethanes, fatty acids and mixtures thereof.

### Detersive Enzymes

Suitable detersive enzymes for optional use herein include protease, amylase, lipase, cellulase, carbohydrase including mannanase and endoglucanase, and mixtures thereof. Enzymes can be used at their art-taught levels, for example at levels recommended by suppliers such as Novo and Genencor. Typical levels in the compositions are from about 0.0001% to about 5%. When enzymes are present, they can be used at very low levels, e.g., from about 0.001% or lower, in certain embodiments of the invention; or they can be used in heavier-duty laundry detergent formulations in accordance with the invention at higher levels, e.g., about 0.1% and higher. In accordance with a preference of some consumers for “non-biological” detergents, the present invention includes both enzyme-containing and enzyme-free embodiments.

### Deposition Aid

As used herein, “deposition aid” refers to any cationic or amphoteric polymer or combination of cationic and amphoteric polymers that significantly enhance the deposition of the fabric care benefit agent onto the fabric during laundering. Preferably, the deposition aid, where present, is a cationic or amphoteric polymer.

### Rheology Modifier

In a preferred embodiment of the present invention, the composition comprises a rheology modifier. Generally the rheology modifier will comprise from 0.01% to 1% by weight, preferably from 0.05% to 0.75% by weight, more preferably from 0.1% to 0.5% by weight, of the compositions herein. Preferred rheology modifiers include crystalline, hydroxyl-containing rheology modifiers include castor oil and its derivatives, polyacrylate, pectine, alginate, arabinogalactan (gum Arabic), carrageenan, gellan gum, xanthan gum, guar gum and mixtures thereof.

### Builder

The compositions of the present invention may optionally comprise a builder. Suitable builders include polycarboxylate builders, citrate builders, nitrogen-containing, phosphor-free aminocarboxylates include ethylene diamine disuccinic acid and salts thereof (ethylene diamine disuccinates, EDDS), ethylene diamine tetraacetic acid and salts thereof (ethylene diamine tetraacetates, EDTA), and diethylene triamine penta acetic acid and salts thereof (diethylene triamine penta acetates, DTPA) and water-soluble salts of homo- and copolymers of aliphatic carboxylic acids such as maleic acid, itaconic acid, mesaconic acid, fumaric acid, aconitic acid, citraconic acid and methylenemalonic acid.

### Encapsulated Composition

The compositions of the present invention may be encapsulated within a water-soluble film. The water-soluble film may be made from polyvinyl alcohol or other suitable variations, carboxy methyl cellulose, cellulose derivatives, starch, modified starch, sugars, PEG, waxes, or combinations thereof. In another embodiment the water-soluble film may include a co-polymer of vinyl alcohol and a carboxylic acid. The water-soluble film herein may also comprise ingredients other than the polymer or polymer material. For example, it may be beneficial to add plasticisers, for example glycerol, ethylene glycol, diethyleneglycol, propane diol, 2-methyl-1,3-propane diol, sorbitol and mixtures thereof, additional water, disintegrating aids, fillers, anti-foaming agents, emulsifying/dispersing agents, and/or antiblocking agents. It may be useful that the pouch or water-soluble film itself comprises a detergent additive to be delivered to the wash water, for example organic polymeric soil release agents, dispersants, dye transfer inhibitors. Optionally the surface of the film of the pouch may be dusted with fine powder to reduce the coefficient of friction. Sodium aluminosilicate, silica, talc and amylose are examples of suitable fine powders.

The encapsulated pouches of the present invention can be made using any convention known techniques. More preferably the pouches are made using horizontal form filling thermoforming techniques.

### EXAMPLES

The following non-limiting examples are illustrative of the present invention. Percentages are by weight unless otherwise specified.

### Example 1

### Preparation of a Perfume Microcapsule Slurry with a Melamine Formaldehyde Capsule (80 wt % Core/20 wt % Wall)

18 grams of a blend of 505 butyl acrylate-acrylic acid copolymer emulsifier (Colloid C351, 25% solids, pka 4.5-4.7, (Kemira Chemicals, Inc. Kennesaw, Ga. U.S.A.) and 50% polyacrylic acid (35% solids, pKa 1.5-2.5, Aldrich) is dissolved and mixed in 200 grams deionized water. The pH of the solution is adjusted to pH of 3.5 with sodium hydroxide solution. 6.5 grams of partially methylated methylol melamine resin (Cymel 385, 80% solids, (Cytec Industries West Paterson, N.J., U.S.A.)) is added to the emulsifier solution. 200 grams of perfume oil is added to the previous mixture under mechanical agitation and the temperature is raised to 60° C. After mixing at higher speed until a stable emulsion is obtained, the second solution and 3.5 grams of sodium sulfate salt are poured into the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.6, 30 grams of partially methylated methylol melamine resin (Cymel 385, 80% solids, Cytec). This mixture is heated to 85° C., and maintained 8 hours with continuous stirring to complete the encapsulation process. 23 grams of acetoacetamide (Sigma-Aldrich, Saint Louis, Mo., U.S.A.) is added to the suspension.

### Example 2

### Preparation of a Perfume Microcapsule Slurry with a Melamine Formaldehyde Capsule (84 wt % Core/16 wt % Wall)

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, N.J., U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stifling to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 3

### Sample Preparation and Storage Test

1.8 g of the perfume microcapsule described in example 2 containing 30% perfume oil (defined below) were mixed with 50 g of formulations A to D (as detailed below) in glass jars (size of 100 mL). Zeta Potential for Perfume Microcapsule of the example above is “−60 meV. The glass jars are closed and stored in an oven at 37° C. for two weeks. After two weeks the samples are taken out of the oven for measurement and the amount of perfume leaked out from the capsules into the liquid was determined by measuring headspace over 5 g of the mixture in a 20 mL headspace vial.

### Perfume Oil 1

| Perfume oil 1 | cLogP | Boiling Point | Leakage |
|---|---|---|---|
| Linalool | 2.43 | 198° C. | 100% |
| Benzaldehyde | 1.48 | 179 | <5% |
| Benzyl acetate | 1.68 | 215° C. | 100% |
| Alpha-terpineol | 2.16 | 219° C. | <5% |
| Hedione | | | <5% |
| Coumarin | 1.412 | 291° C. | <5% |
| Dihydromyrcenol | 3.03 | 205° C. | <5% |
| Lilial | 4.14 | 290° C. | <5% |
| Hexyl cinnamic | 4.68 | 334° C. | <5% |
| aldehyde | | | |
| % Quadrant 1 PRM | | | 18% |

### Head-Space Analysis

5 grams of the detergent mixture is placed in a 20 mL headspace vial and the vial is capped. All samples vial are put on an autosampler tray of the Static Headspace sampler type HP7694 (Hewlett Packard, Agilent Technologies, Palo Alto, Calif.). Prior to the headspace analysis, each sample is pre-conditioned for 30 minutes at 40° C. A headspace loop of 3 mL is transferred (via inert transfer line at 80° C.) onto GC-MS system. GC-analysis is conducted on apolar capillary column (DB-5, 30 meters×0.25 mm, 1 micron thickness) and headspace constituents (i.e. the perfume raw materials) are monitored by Mass Spectrometry (EI, 70 eV detector).

Leakage is determined comparing the headspace responses for both reference containing perfume oil (free perfume without microcapsules) and product containing perfume microcapsule. The percent leakage is calculated on the basis of % contribution of each individual perfume raw material and the total perfume leakage is the sum of all % leakage of each individual perfume raw materials.

The results of the four detergent liquids are tabulated below.

| | | Formu- | | Formu- |
|---|---|---|---|---|
| | Formulation A | lation B | Formulation C | lation D |
| Monopropylene | 39% | 35.9% | 33.7% | 31% |
| glycol | | | | |
| Water | 38.9% | 35.8% | 0 | 0 |
| LAS | 10% | 9.2% | 30% | 27.6% |
| Neodol C12EO7 | 10% | 9.2% | 30% | 27.6% |
| MEA | 2.1% | 1.9% | 6.3% | 5.8% |
| Na-citrate | | 8% | | 8 |
| CalciumCl2 | 0.01% | 0.01% | 0.01% | 0.01% |
| Ionic strength | 0 | 0.375 | 0 | 0.375 |
| % Perfume | 64% | 36% | 56% | 31% |
| Leakage | | | | |

### Example 4

The table below represents an example of a composition falling within the scope of the present invention. Compositions A and B represent liquid compositions. Composition C is an example of a single compartment pouch unit dose wherein the composition is enclosed within a water-soluble film, Monosol M8630 76 μm thickness.

| | A | B | C |
|---|---|---|---|
| Ingredients | Weight % | | |
| Alkylbenzene sulfonic | 25 | 30 | 21.0 |
| acid | | | |
| C₁₂₋₁₄ alkyl 7- | 20 | 25 | 8.0 |
| ethoxylate | | | |
| C₁₂₋₁₄ alkyl ethoxy 3 | 5 | | 7.5 |
| sulfate | | | |
| Citric acid | | 2 | |
| C₁₂₋₁₈ Fatty acid | 10 | 5 | |
| Sodium citrate | | | 5 |
| enzymes | | 0-5 | 0-3 |
| Ethoxylated | | | 2.0 |
| Polyethylenimine¹ | | | |
| Hydroxyethane | 2.5 | | 0.5 |
| diphosphonic acid | | | |
| Brightener | | | 0.2 |
| PMC² | 1.5 | 1.2 | 1.0 |
| Water | 15 | 12 | 30 |
| Solvent | | | |
| MgCl2 | 0.1 | | |
| CaCl2 | | 0.01 | |
| Perfume | | 1.0 | 1.5 |
| 1,2-propane diol | 20 | 15 | 10 |
| Minors (antioxidant, | | | |
| sulfite, aesthetics, . . . ) | | | |

| | |
|---|---|
| Buffers | To pH 8.0 for liquids |
| (monoethanolamine) | |
| | To 100 p |

¹Polyethylenimine (MW = 600) with 20 ethoxylate groups per —NH.
²PMC: Perfume Micro Capsule: Perfume oil encapsulated in a melamine-formaldehyde shell with zeta potential −60 meV

### Example 5

The following are examples of pouch unit dose executions wherein the liquid composition is enclosed within a PVA film. The preferred film used in the present examples is Monosol M8630 76 μm thickness. Examples D and F describe pouches with 3 compartments; 1, 2 and 3. Example E describes a pouch with 2 compartments.

| | D | | | E | | F | | |
|---|---|---|---|---|---|---|---|---|
| | 3 compartments | | | 2 compartments | | 3 compartments | | |
| Compartment # | 1 | 2 | 3 | 1 | 2 | 1 | 2 | 3 |
| Dosage (g) | 34.0 | 3.5 | 3.5 | 30.0 | 5.0 | 25.0 | 1.5 | 4.0 |
| Ingredients | Weight % | | | | | | | |
| Alkylbenzene sulfonic acid | 20.0 | 20.0 | 20.0 | 10.0 | 20.0 | 20.0 | 25 | 30 |
| Alkyl sulfate | | | | 2.0 | | | | |
| C₁₂₋₁₄ alkyl 7-ethoxylate | 17.0 | 17.0 | 17.0 | | 17.0 | 17.0 | 15 | 10 |
| C₁₂₋₁₄ alkyl ethoxy 3 sulfate | 7.5 | 7.5 | 7.5 | | | 7.5 | 7.5 | |
| Citric acid | 0.5 | | 2.0 | 1.0 | | | | 2.0 |
| Zeolite A | | | | 10.0 | | | | |
| C₁₂₋₁₈ Fatty acid | 13.0 | 13.0 | 13.0 | | 18.0 | 18.0 | 10 | 15 |
| Sodium citrate | | | | 4.0 | 2.5 | | | |
| enzymes | 0-3 | 0-3 | 0-3 | 0-3 | | 0-3 | 0-3 | 0-3 |
| Sodium Percarbonate | | | | 11.0 | | | | |
| TAED | | | | 4.0 | | | | |
| Polycarboxylate | | | | 1.0 | | | | |
| Ethoxylated | 2.2 | 2.2 | 2.2 | | | | | |
| Polyethylenimine¹ | | | | | | | | |
| Hydroxyethane | 0.6 | 0.6 | 0.6 | 0.5 | | | 2.2 | |
| diphosphonic acid | | | | | | | | |
| Ethylene diamine tetra | | | | | | 0.4 | | |
| (methylene phosphonic) acid | | | | | | | | |
| Brightener | 0.2 | 0.2 | 0.2 | 0.3 | | 0.3 | | |
| PMC² | | | 1.5 | | 1.3 | | 0.12 | 0.2 |
| Water | 9 | 8.5 | 10 | 5 | 11 | 10 | 10 | 9 |
| CaCl2 | | | | | | | 0.01 | |
| Perfume | 1.7 | 1.7 | | 0.6 | | 1.5 | 0.5 | |
| Minors (antioxidant, | 2.0 | 2.0 | 2.0 | 4.0 | 1.5 | 2.2 | 2.2 | 2.0 |
| sulfite, aesthetics, . . . ) | | | | | | | | |

| | |
|---|---|
| Buffers (sodium carbonate, | To pH 8.0 for liquids |
| monoethanolamine)³ | To RA >5.0 for powders |
| Solvents (1,2 propanediol, | To 100 p |
| ethanol), Sulfate | |

¹Polyethylenimine (MW = 600) with 20 ethoxylate groups per —NH.
³RA = Reserve Alkalinity (g NaOH/dose)
²PMC: Perfume Micro Capsule: Perfume oil encapsulated in a melamine-formaldehyde shell with zeta potential −60 meV

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising from about 0.01 to about 40% by weight water, benefit agent-containing microcapsules and an ionic species having at least 2 anionic sites, wherein the ionic species delivers an ionic strength greater than about 0.045 mol/kg.

2. The liquid detergent composition according to claim 1 wherein the composition comprises from about 1 to about 25% by water.

3. The liquid detergent composition according to claim 1 wherein the benefit agent is selected from the group of include perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, dyes, brighteners, antibacterial actives, antiperspirant actives, cationic polymers and mixtures thereof.

4. The liquid detergent composition according to claim 1 wherein the benefit agent is a perfume comprising perfume raw materials that are selected such that less than about 15% of the perfume raw materials have Clog P less than about 3 and a boiling point less than about 250° C. and the remaining perfume raw materials have Clog P of greater than about 3 and/or Clog P less than about 3, but having boiling point of greater than about 250° C.

5. The liquid detergent composition according to claim 1 wherein the ionic species having at least 2 anionic sites is selected from the group of carboxylic acids, polycarboxylate, phosphate, phosphonate, poly phosphate, polyphosphonate, borate and mixtures thereof.

6. The liquid detergent composition according to claim 5 wherein the ionic species having at least 2 anionic sites is selected from the group of oxydisuccinic acid, aconitic acid, citric acid, tartaric acid, malic acid, maleic acid, fumaric acid, succinic acid, sepacic acid, citaconic acid, adipic acid, itaconic acid, dodecanoic acid and mixtures thereof.

7. The liquid detergent composition according to claim 5 wherein the ionic species having at least 2 anionic sites is selected from the group of acrylic acid homopolymers and copolymers of acrylic acid and maleic acid.

8. The liquid detergent composition according to claim 1 additionally comprising positively charged ion comprising at least 2 cationic sites.

9. The liquid detergent composition according to claim 8 wherein the positively charged ion is selected from the group of calcium, magnesium, iron, manganese, cobalt, copper, zinc ions and mixtures thereof.

10. The liquid detergent composition according to claim 1 wherein the microcapsule has a zeta potential of from about −0.1 to about −100 meV when dispersed in deionized water.

11. The liquid detergent composition according to claim 1 additionally comprising enzyme.

12. A liquid detergent composition comprising from about 0.01 to about 40% by weight water, benefit agent-containing microcapsules and an ionic species having at least 2 anionic sites, wherein the ionic species delivers an inionic of greater than about 0.045 mol/kg and wherein the composition is enveloped in a water-soluble film.

13. The liquid detergent composition according to claim 12 wherein the water-soluble film is selected from polyvinyl alcohol, polyvinyl acetate and mixtures thereof.
